(19) United States
(12) Patent Application Publication
(10) Pub. No.: US 2020/0167353 A1
(43) Pub. Date: May 28, 2020

(54) Automated Data Source Join Proposals Based on Process Relations

(71) Applicant: SAP SE, Walldorf (DE)

(72) Inventors: Stefan Kraus, Brushsal (DE); Raffael Lutz, Bad Schönborn (DE); Dirk Baumgaertel, Altlußheim (DE); Sonja Barnet, Viernheim (DE); Gaurav Kumar, Madhepura Bihar (IN); Vivek Methi, Anjangaon Surji (IN)

(21) Appl. No.: 16/200,284

(22) Filed: Nov. 26, 2018

(51) Int. Cl. G06F 16/2455; G06F 16/2457; G06F 16/22; G06F 16/93

(52) U.S. Cl. CPC G06F 16/2456; G06F 16/93; G06F 16/2282; G06F 16/24573

(57) ABSTRACT

Systems, methods, and computer programmable products are described for automated data source join proposals based on process relations. Data encapsulating a first data source and one or more data fields within the first data source is received. A data object model of the first data source is generated based on the one or more fields. A plurality of data sources are searched for the one or more data fields to identify a second data source having one or more related fields. A technical relationship is defined between the first data source and the second data source based on the one or more data fields. A join condition is determined between the first data source and the second data source based on the defined technical relationship. The join condition is provided for confirmation of joining the one or more fields of the first data source and the second data source.

### TECHNICAL FIELD

The subject matter described herein relates to enhanced techniques for automated data source join proposals based on process relations within metadata.

### BACKGROUND

Analysis of various data sources can be used to gain an understanding of a particular computer-implemented process such as performance or efficiency of a computer-implemented process. Relevant information can be stored in hundreds of different data sources. The data sources can be document oriented data tables which include technical keys and technical reference information. Joining of the data sources can link information across multiple data sources to provide an end-to-end analysis of a particular computer-implemented process. In joining the data sources, however, a user may need to have technical knowledge on metadata within each data source. For example, a user may need to understand the header information of the documents in order to properly join them. Such joins can require a technical analysis of the contents of a particular document along with generation of a technical keys to understand how the data sources are related. For example, how invoices relate to deliveries and/or how deliveries relate to sales orders.

### SUMMARY

In one aspect, data derived by user input via a graphical user interface is received. The data encapsulates a first data source and one or more data fields within the first data source. A data object model of the first data source is generated based on the one or more fields. A plurality of data sources are searched for the one or more data fields to identify a second data source having one or more related fields. A technical relationship between the first data source and the second data source is defined based on the one or more data fields. A join condition between the first data source and the second data source is determined based on the defined technical relationship. The join condition is provided to a user via the graphical user interface for confirmation of joining the one or more fields of the first data source and the second data source.

In some variations, via user input via the graphical user interface, a confirmation of the join condition can be received. A joined data source can be generated. The joined data source can include the one or more fields from the first data source and one or more related fields from the second data source. The joined data source can be interactively analyzed via the graphical user interface.

In other variations, based on user input via the graphical user interface, the first data source can be removed from the join condition. A third data source can be added based on user input via the graphical user interface. A selection, based on user input via the graphical user interface, one or more fields of the third data source can be received. The generating, determining, and providing can be repeated using the third data source in place of the first data source.

In some variations, a second join condition to a fourth data source can be generated based on a number of fields of the technical reference. The technical relationship can contain the one or more fields within the first data source and a reference field to a type of the second data source. The technical relationship can also be based on metadata stored within the first data source and the second data source.

In other variations, the first data source can contain document types including a sales order, a customer invoice, a clearing document, a payment order, or a bank payment order.

Non-transitory computer program products (i.e., physically embodied computer program products) are also described that store instructions, which when executed by one or more data processors of one or more computing systems, cause at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The subject matter described herein provides many technical advantages. For example, the current subject matter can provide data object models that consistently define various documents in a generic language to provide uniformity across the data sources. This uniform world can interpret various data object models and can automatically create a proposal for how to join various data sources.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1A is a block diagram illustrating an example document chain;

FIG. 1B is a block diagram illustrating an example of related data sources;

FIG. 2 illustrates an example system architecture for use in connection with the current subject matter;

FIG. 3 illustrates an example user interface for a user in generating automatic join proposals of using the field selections described in FIG. 2;

FIG. 4 illustrates an example user interface for a user to view, modify, or accept a proposed join condition;

FIG. 5 is a process flow diagram illustrating the generation of a join condition; and

FIG. 6 is a diagram illustrating a sample computing device architecture for implementing various aspects described herein.

Like reference symbols in the various drawings indicate like elements.

### DETAILED DESCRIPTION

Transparency into an end-to-end computer-implemented process can be important to understand how to evaluate performance of a particular process. For example, a user may be interested in process efficiencies of a particular aspect of a computer-implemented process, reporting on process lead times, or traceability of an end-to-end logistics platform. A user can, using the user interface (UI) capabilities described herein, be provided with guidance on how to define joined data sources by leveraging references of document chains. Using the subject matter described herein, a user no longer needs to have technical knowledge to join multiple data sources. Rather, a UI can automatically generate join proposals to a user by generating data model objects on top of document types and technical references between multiple data sources. The join proposals can occur in manner that is transparent to a user. An automated join proposal can be generated to guide a user within a modeled UI by providing step-by-step assistance in joining data sources, as described herein.

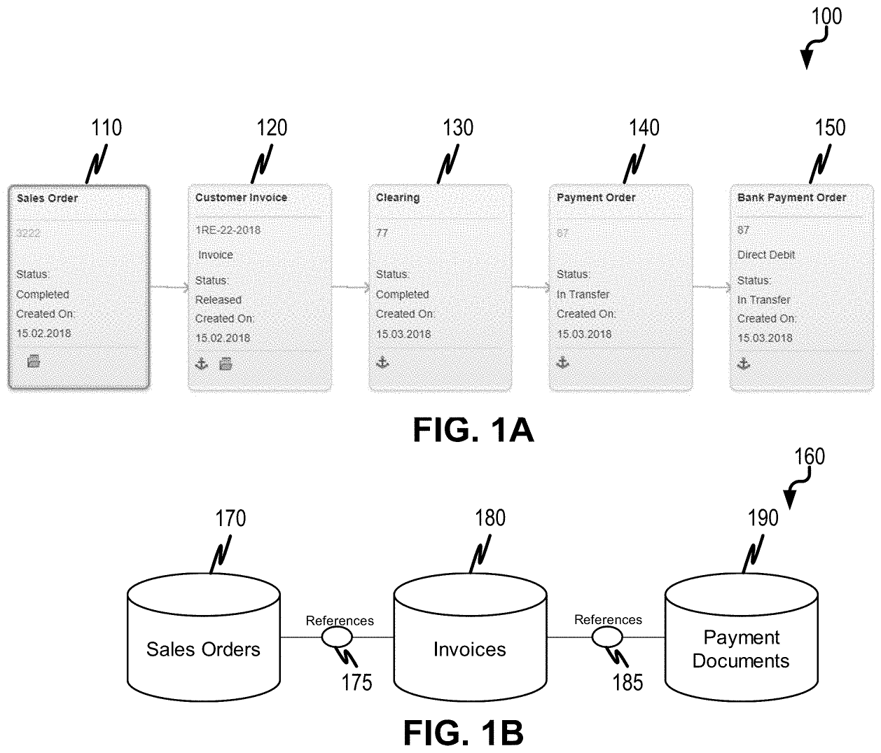

FIG. 1A is a block diagram illustrating an example document chain 100. Document chain 100 can include a number of document types such as sales orders 110, customer invoices 120, clearing documents 130, payment orders 140, and/or bank payment orders 150. Each of the document types 110, 120, 130, 140, 150 can be represented as data objects having relationships between the documents types. The document type relationships can be modeled as technical references stored within data objects, as described in more detail in FIG. 1B.

FIG. 1B is a block diagram illustrating an example of related data sources 160. Related data sources 160 can include a number of data objects each containing information related across the chain. For example, related data sources 160 can include sales orders data object 170, invoices data object 180, and payment document data object 190. The content within sales orders data object 170 can be related to the content within invoice data object 180 (e.g., based on customer name, address, phone number, order specifics). The relationship between the sales orders data object 170 and the invoice data object 180 can be represented by technical references 175. Similarly, the content of invoice data object 180 can be related to the content of payment documents data object 190. For example, a relationship can exist between a sales order data object 170 and customer invoice data object 180. If a user wants to report on both the sales order data object 170 and customer invoice data object 180, a joined data source is generated to join the two data objects. Technical references 185 can represent the relationship between invoice data source 180 and payment documents data source 190. The overlapping information can be identified with, for example, header information contained within each document. The overlapping information between the document types can be represented by technical references. With technical references 175, 185, a UI can automatically be proposed to a user with relevant data sources that a user can use to analyze an end-to-end document chain such as document chain 100. The data objects and technical references can provide homogenous language to relate a large number of data sources.

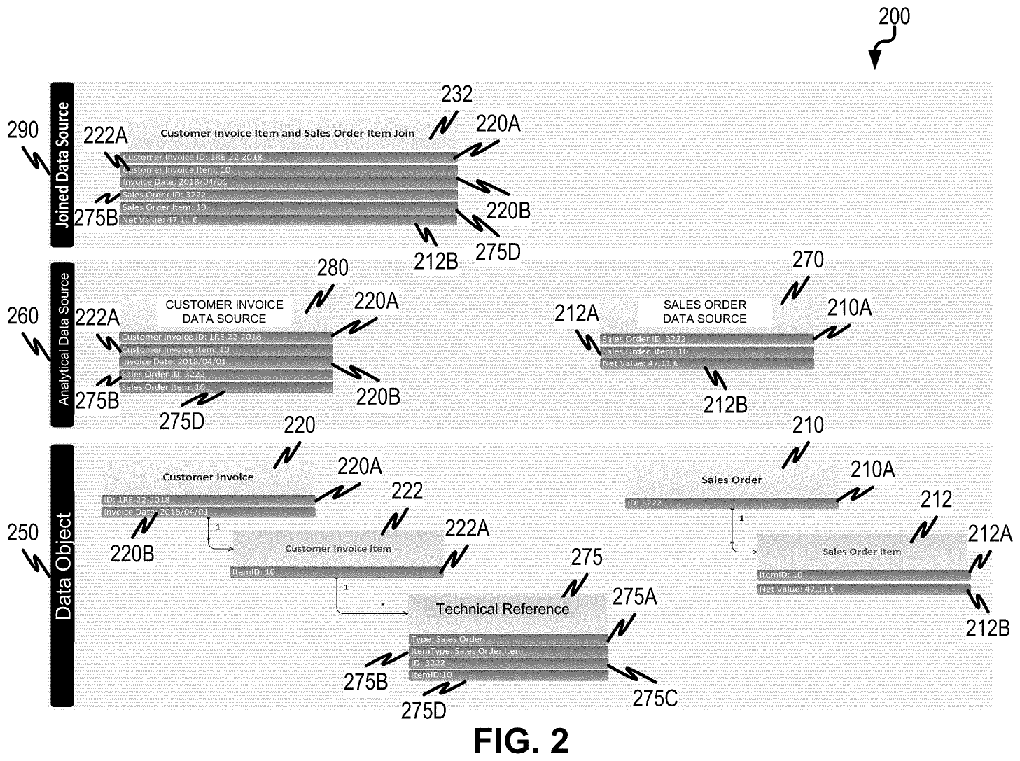

FIG. 2 illustrates an example system architecture 200 for use in connection with the current subject matter. Example system architecture 200 illustrates the relationship between document types customer invoice 120 and sales order 110. Such example is for illustrative purposes. It is recognized that this relationship can be created between any number of different document types or data sources, not limited to those examples in FIG. 2. Data object 250 can be a generic representation of document type that contain metadata (e.g., sales orders 110, customer invoices 120, clearing documents 130, payment orders 140, and/or bank payment orders 150). This generic representation can be used for the data objects to relate any number of data types together without needing technical knowledge of the underlying metadata. Relationships can be used to link one data source with another data source. The reference information stored within the data source can be used to create a join condition. The data sources can be linked together using the generated relationships.

Each data object 250 can include a number of fields contained within the document type. Customer invoice 220 can, for example, include field 220A (e.g., invoice identification) and field 220B (e.g., invoice date). Customer invoice 220 can also include a customer invoice item 222 having a field 222A (e.g., item identification. In another example, sales order 210 can include field 210A (e.g., identification). Sales order 210 can also include sales order item 212 having field 212A (e.g., item identification) and field 212B (e.g., net value).

Data objects 250 can also store the technical references 275 between a number of document types. A technical reference between, for example, customer invoice 220 and sales order 210 can be generated to include relationship data between the two document types. For example, technical reference 275 for customer invoice 220 can indicate a relationship to document type sales order 210 via field 275A. Technical relationship can also include identification of a sales order item 212 via field 275B, identification of the sales order fields (e.g., 210A) via field 275C, and identification of the customer invoice item field 222A via field 275D. The data object 250 for a customer invoice can include the customer invoice data type 220, customer invoice item 222, and technical reference 275. The data object 250 for a sales order can include sales order document type 210 and sales order item 212.

Analytical data sources 260 can be modeled on top of each data object 210 such that the fields of the data source represent the fields of each data object. Each data source can contain the information contained (e.g., fields) within the data object 210. A user can select a number of fields for each data source that are relevant to a particular analysis. For example, customer invoice data source 280 can be modeled on top of the customer invoice data object. In this example, the user selected fields include field 220A (e.g., customer invoice identification), field 220B (e.g., customer invoice date), field 222A (e.g., customer item identification), field 275C (e.g., technical reference 275 field sales order identification), and field 275D (e.g., technical reference 275 field sales order item). Similarly, sales order data source 270 can be modeled on top of the data object for sales orders 210. In this example, a user selected a number of fields within sales order data source 280 including field 210A (e.g., sales order identification), field 212A (e.g., sales order item identification), and field 212B (e.g., net value). The user selection is translated into data which encapsulates the data source along with the selected fields.

For example, if a user selects a field “delivery item ID”, the metadata of the data object can identify that the field refers to another document type. The data sources that are built on top of the field can be identified. Suggestions of these related data sources can be provided to a user based on this metadata. With the join relationships, users no longer need to understand the data types such as universal unique identifiers (UUIDs) and external IDs. The join relationship automatically proposes data sources that have matching data types such as UUIDs or external IDs. The metadata identifies the source of the sales order 210. Utilizing the existing database tables, the application extracts a field and maps that field to another data object such as an invoice 220.

Based on the technical references between various data sources, a join proposal can be automatically generated to propose a join condition between related data sources. The join proposal, once accepted by a user, can generate a joined data source 270 containing a coherent data source 232. For example, in FIG. 2, a user can select a customer invoice data source 280. Based on the technical reference 275, between customer invoice data source 280 and sales order item 270, a user can be prompted to generate a joined data source 290. For example, a joined data source 290 can which bring together data within customer invoice data source 280 and sale order data source 270 into a coherent data source 232. With the coherent data source 232, a user can perform analytical processing of the data to analyze the end-to-end process.

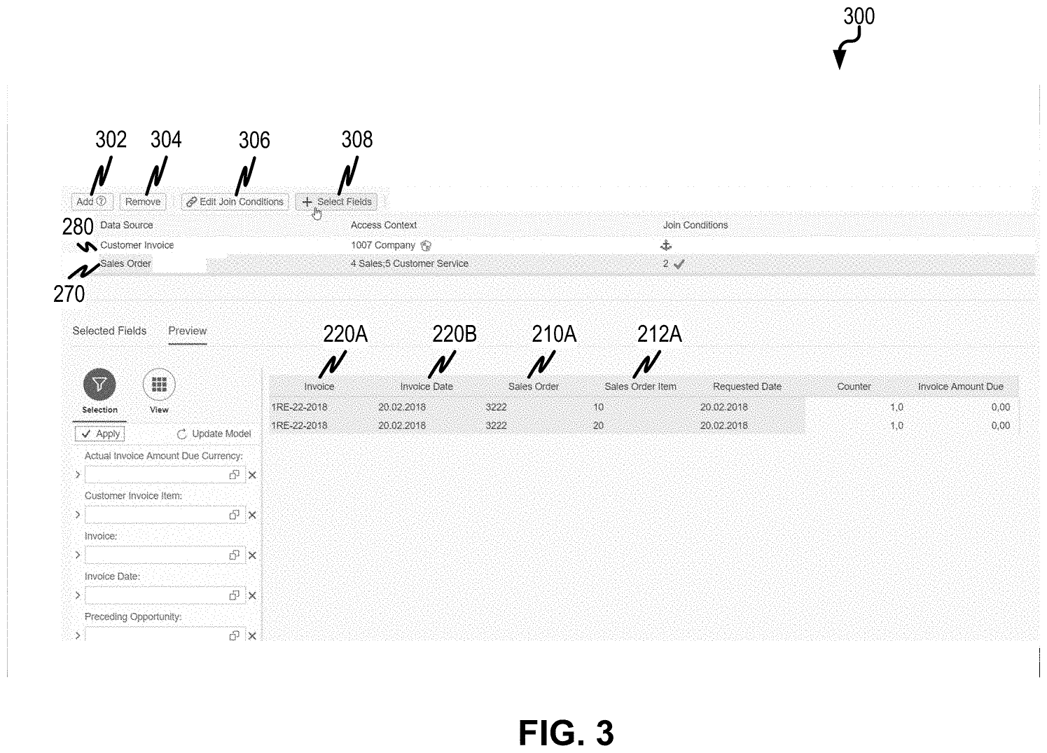

A user can be guided through the creation of coherent data source 232 using a UI. FIG. 3 illustrates an example UI 300 for a user in generating automatic join proposals of using the field selections described in FIG. 2. UI 300 can include a number of selectable user functionality buttons such as add button 302, remove button 304, edit join conditions button 306, and select fields button 308. Using UI 300, a user can initially select a first data source for analysis. For example, using the add button 302 a user can add the customer invoice data source 280 for analysis. A user can also remove selected data sources using the remove button 304. Once a data source is selected, such as customer invoice data source 280, a user can select the specific fields within that selected data source to analyze using the select fields button 308. In this example, the user selected fields for the customer invoice data source 280 include field 220A (e.g., customer invoice identification) and field 220B (e.g., customer invoice date). Based on the user selection of the customer invoice data source 280, the UI 300 can propose the selection of the sales order data source 270 based on the technical reference 275 between the two data sources. A data processor generating the UI 300 can automatically determine a join condition based on the technical reference 275 using the generated data objects. With the join condition, the coherent data source 232 can be generated. A user can utilize this coherent data source 232 to further perform analysis on the end-to-end process of a particular transaction.

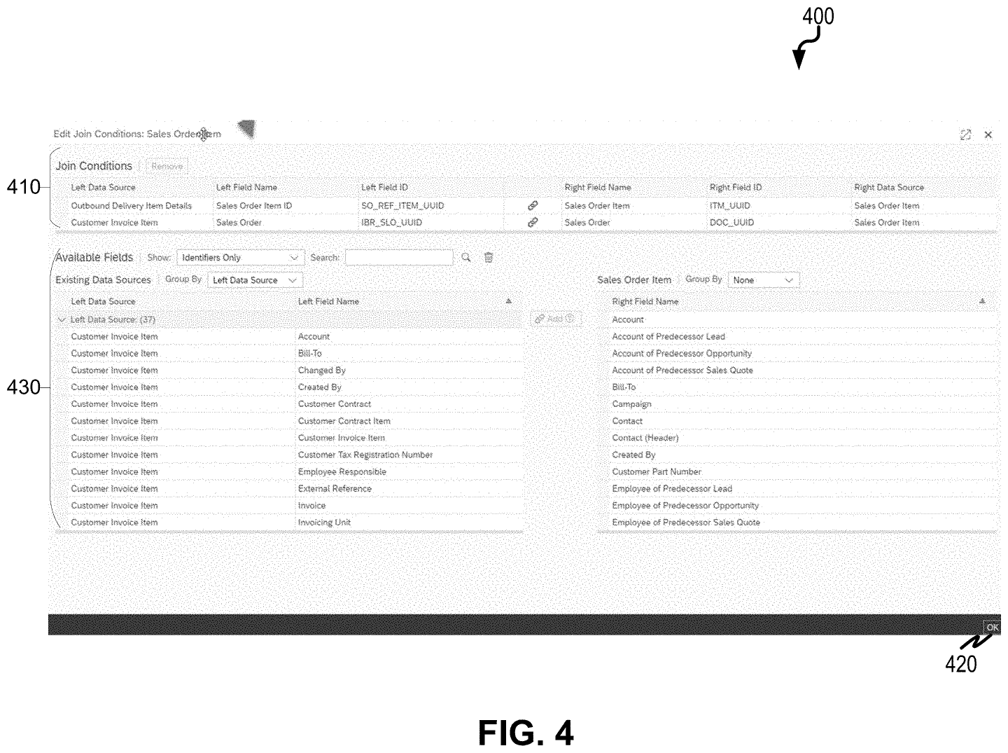

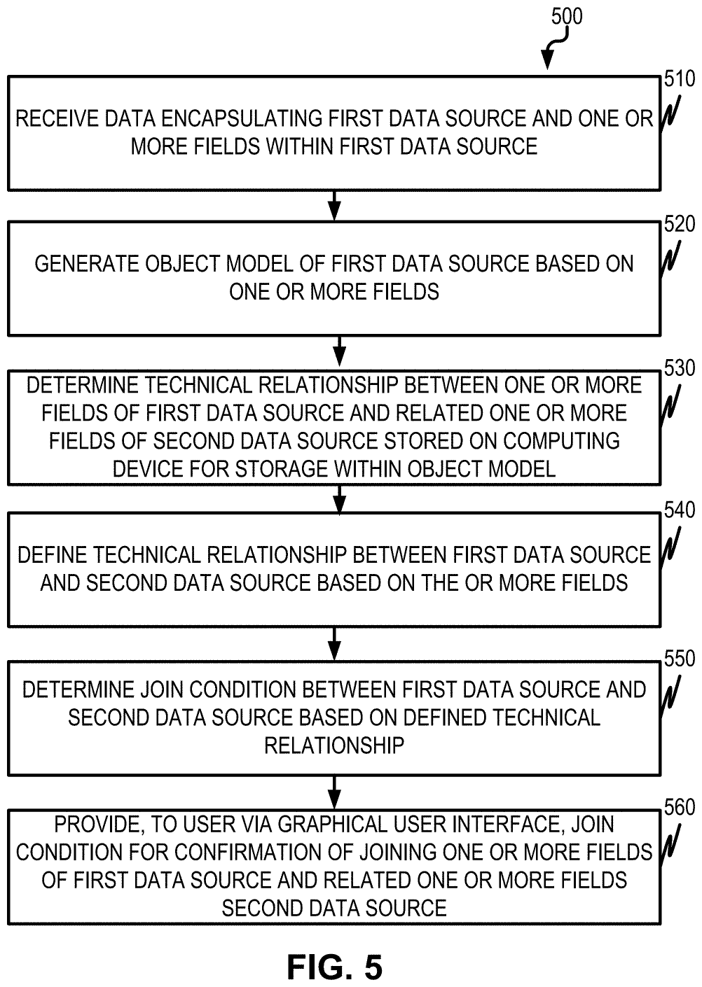

FIG. 4 illustrates an example UI 400 for a user to view, modify, or accept a proposed join condition. A user can be guided interactively throughout the join proposal creation process. Once a join condition is determined between at least two data sources based upon the technical relationship, a user can interactively view, confirm or accept, and/or modify the proposed join condition. For example, proposed join conditions 410 can be provided to a user via UI 400. A user can choose to confirm or accept the proposed join condition by, for example, selecting confirmation button 420 (e.g., “OK”). A user can also modify a proposed join condition by selecting one or more other available fields (e.g., fields 430) which are compatible with the initially selected data source. Based on user input to accept or confirm the changes a joined data source can be generated to include the one or more fields from the first data source and one or more related fields from the second data source. If a user modifies the join condition 410 via user input, then another proposed join condition can be generated by repeating the steps described in FIG. 5 with a newly selected data source.

FIG. 5 is a process flow diagram 500 illustrating the generation of a join condition. A user provides, at 510, data encapsulating a first data source and one or more data fields within the first data source via a graphical user interface. A data object model of the first data source is generated, at 520, based on the one or more fields. A second data source having related fields to the one or more data fields of the first data source can be identified by searching, at 530, amongst a plurality of data source. A technical relationship between the first data source and the second data source can be defined, at 540, based on the one or more fields. The defined technical relationship is stored within the object model. A join condition between the one or more fields of the first data source and the related one or more fields of the second data source is determined, at 550, based on the defined technical relationship. The join condition is provided to a user, at 560, for confirmation of joining the one or more fields of the first data source and the one or more related fields of the second data source.

For example, a user can select the sales order data source 270 along with the field “buyer”. A listing of all data sources which contain the field “buyer” can be generated (e.g., join condition). The user can select one of the data sources from the listing and a coherent data source can be generated having the buyer field from the sales order data source 270 and the user selected data source. In some cases, more than one join condition can be required based on the number of related data sources. The number of join conditions proposed to the user can be based on the complexity of the related data sources.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “computer-readable medium” refers to any computer program product, apparatus and/or device, such as for example magnetic discs, optical disks, memory, and Programmable Logic Devices (PLDs), used to provide machine instructions and/or data to a programmable processor, including a computer-readable medium that receives machine instructions as a computer-readable signal. The term “computer-readable signal” refers to any signal used to provide machine instructions and/or data to a programmable processor. The computer-readable medium can store such machine instructions non-transitorily, such as for example as would a non-transient solid-state memory or a magnetic hard drive or any equivalent storage medium. The computer-readable medium can alternatively or additionally store such machine instructions in a transient manner, for example as would a processor cache or other random access memory associated with one or more physical processor cores.

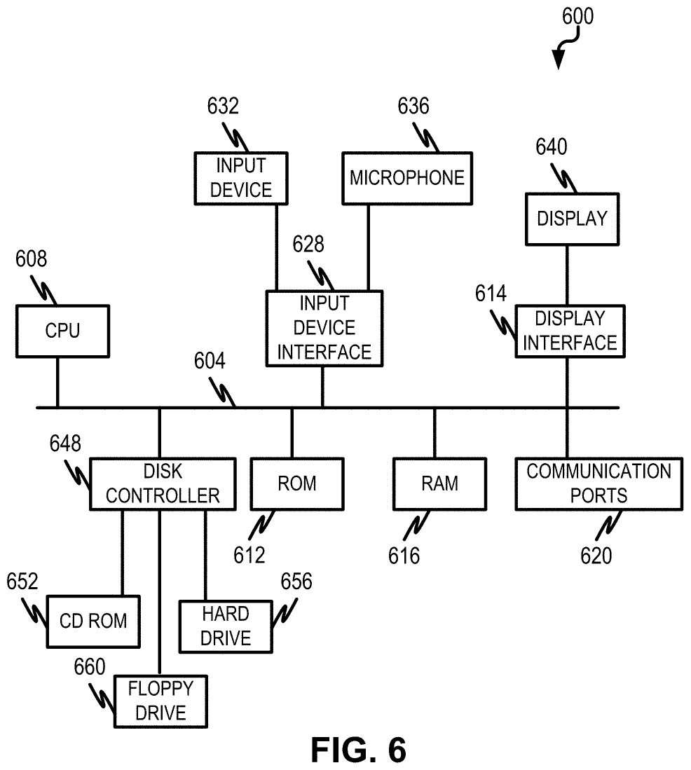

FIG. 6 is a diagram 600 illustrating a sample computing device architecture for implementing various aspects described herein. A bus 604 can serve as the information highway interconnecting the other illustrated components of the hardware. A processing system 508 labeled CPU (central processing unit) (e.g., one or more computer processors/data processors at a given computer or at multiple computers), can perform calculations and logic operations required to execute a program. A non-transitory processor-readable storage medium, such as read only memory (ROM) 612 and random access memory (RAM) 616, can be in communication with the processing system 608 and can include one or more programming instructions for the operations specified here. Optionally, program instructions can be stored on a non-transitory computer-readable storage medium such as a magnetic disk, optical disk, recordable memory device, flash memory, or other physical storage medium.

In one example, a disk controller 648 can interface one or more optional disk drives to the system bus 604. These disk drives can be external or internal floppy disk drives such as 660, external or internal CD-ROM, CD-R, CD-RW or DVD, or solid state drives such as 652, or external or internal hard drives 656. As indicated previously, these various disk drives 652, 656, 660 and disk controllers are optional devices. The system bus 604 can also include at least one communication port 620 to allow for communication with external devices either physically connected to the computing system or available externally through a wired or wireless network. In some cases, the communication port 620 includes or otherwise comprises a network interface.

To provide for interaction with a user, the subject matter described herein can be implemented on a computing device having a display device 640 (e.g., a CRT (cathode ray tube) or LCD (liquid crystal display) monitor) for displaying information obtained from the bus 604 to the user and an input device 632 such as keyboard and/or a pointing device (e.g., a mouse or a trackball) and/or a touchscreen by which the user can provide input to the computer. Other kinds of input devices 632 can be used to provide for interaction with a user as well; for example, feedback provided to the user can be any form of sensory feedback (e.g., visual feedback, auditory feedback by way of a microphone 636, or tactile feedback); and input from the user can be received in any form, including acoustic, speech, or tactile input. In the input device 632 and the microphone 636 can be coupled to and convey information via the bus 604 by way of an input device interface 628. Other computing devices, such as dedicated servers, can omit one or more of the display 640 and display interface 614, the input device 632, the microphone 636, and input device interface 628.

To provide for interaction with a user, the subject matter described herein can be implemented on a computer having a display device (e.g., a CRT (cathode ray tube) or LCD (liquid crystal display) monitor) for displaying information to the user and a keyboard and a pointing device (e.g., a mouse or a trackball) and/or a touchscreen by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method implemented by one or more data processors forming one or more computing devices, the method comprising:
receiving, by at least one data processor derived by user input via a graphical user interface, data encapsulating a first data source and one or more data fields within the first data source;
generating, by at least one data processor, a data object model of the first data source based on the one or more fields;
searching, by at least one data processor, amongst a plurality of data sources for the one or more data fields to identify a second data source having one or more related fields;
defining, by at least one data processor, a technical relationship between the first data source and the second data source based on the one or more data fields;
determining, by at least one data processor, a join condition between the first data source and the second data source based on the defined technical relationship; and
providing, to a user via the graphical user interface, the join condition for confirmation of joining the one or more fields of the first data source and the second data source.

2. The method of claim 1, further comprising:
receiving, by user input via the graphical user interface, a confirmation of the join condition; and
generating, by at least one data processor, a joined data source comprising the one or more fields from the first data source and one or more related fields from the second data source.

3. The method of claim 2, further comprising interactively analyzing, via the graphical user interface, the joined data source.

4. The method of claim 1, further comprising:
removing, based on user input via the graphical user interface, the first data source from the join condition;
adding, based on user input via the graphical user interface, a third data source;
receiving a selection, based on user input via the graphical user interface, one or more fields of the third data source; and
repeating the generating, determining, and providing using the third data source in place of the first data source.

5. The method of claim 1, further comprising generating, based on a number of fields of the technical reference, a second join condition to a fourth data source.

6. The method of claim 1, wherein the technical relationship contains the one or more fields within the first data source and a reference field to a type of the second data source.

7. The method of claim 1, wherein the first data source contains document types comprising a sales order, a customer invoice, a clearing document, a payment order, or a bank payment order.

8. The method of claim 1, wherein the technical relationship is based on metadata stored within the first data source and the second data source.

9. A system comprising:
at least one data processor; and
memory storing instructions, which when executed by at least one data processor, result in operations comprising:
receiving, derived by user input via a graphical user interface, data encapsulating a first data source and one or more data fields within the first data source;
generating a data object model of the first data source based on the one or more fields;
searching amongst a plurality of data sources for the one or more data fields to identify a second data source having one or more related fields;
defining a technical relationship between the first data source and the second data source based on the one or more data fields;
determining a join condition between the first data source and the second data source based on the defined technical relationship; and
providing, to a user via the graphical user interface, the join condition for confirmation of joining the one or more fields of the first data source and the second data source.

10. The system of claim 9, wherein the operations further comprise:
receiving, by user input via the graphical user interface, a confirmation of the join condition; and
generating a joined data source comprising the one or more fields from the first data source and one or more related fields from the second data source.

11. The system of claim 10, wherein the operations further comprise interactively analyzing, via the graphical user interface, the joined data source.

12. The system of claim 9, wherein the operations further comprise:
removing, based on user input via the graphical user interface, the first data source from the join condition;
adding, based on user input via the graphical user interface, a third data source;
receiving a selection, based on user input via the graphical user interface, one or more fields of the third data source; and
repeating the generating, determining, and providing using the third data source in place of the first data source.

13. The system of claim 9, wherein the operations further comprise generating, based on a number of fields of the technical reference, a second join condition to a fourth data source.

14. The system of claim 9, wherein the technical relationship contains the one or more fields within the first data source and a reference field to a type of the second data source.

15. The system of claim 9, wherein the first data source contains document types comprising a sales order, a customer invoice, a clearing document, a payment order, or a bank payment order.

16. The system of claim 9, wherein the technical relationship is based on metadata stored within the first data source and the second data source.

17. A non-transitory computer programmable product storing instructions which, when executed by at least one data processor forming part of at least one computing device, implement operations comprising:
receiving, derived by user input via a graphical user interface, data encapsulating a first data source and one or more data fields within the first data source;
generating a data object model of the first data source based on the one or more fields;
searching amongst a plurality of data sources for the one or more data fields to identify a second data source having one or more related fields;
defining a technical relationship between the first data source and the second data source based on the one or more data fields;
determining a join condition between the first data source and the second data source based on the defined technical relationship; and
providing, to a user via the graphical user interface, the join condition for confirmation of joining the one or more fields of the first data source and the second data source.

18. The non-transitory computer programmable product of claim 17, wherein the operations further comprise:
receiving, by user input via the graphical user interface, a confirmation of the join condition;
generating, by at least one data processor, a joined data source comprising the one or more fields from the first data source and one or more related fields from the second data source; and
interactively analyzing, via the graphical user interface, the joined data source.

19. The non-transitory computer programmable product of claim 17, wherein the operations further comprise:
removing, based on user input via the graphical user interface, the first data source from the join condition;
adding, based on user input via the graphical user interface, a third data source;
receiving a selection, based on user input via the graphical user interface, one or more fields of the third data source; and
repeating the generating, determining, and providing using the third data source in place of the first data source.

20. The non-transitory computer programmable product of claim 17, wherein the operations further comprise generating, based on a number of fields of the technical reference, a second join condition to a fourth data source.
